(19) United States
(12) Patent Application Publication
(10) Pub. No.: US 2023/0331618 A1
(43) Pub. Date: Oct. 19, 2023

(54) METHOD AND FACILITY FOR PRODUCING OPTICAL FIBER BASE MATERIAL

(71) Applicant: SUMITOMO ELECTRIC INDUSTRIES, LTD., Osaka-shi, Osaka (JP)

(72) Inventors: Takahiro SAITO, Osaka-shi, Osaka (JP); Keisei MORITA, Osaka-shi, Osaka (JP); Hiroki INOUE, Osaka-shi, Osaka (JP)

(73) Assignee: SUMITOMO ELECTRIC INDUSTRIES, LTD., Osaka-shi, Osaka (JP)

(21) Appl. No.: 18/028,602

(22) PCT Filed: Sep. 27, 2021
(86) PCT No.: PCT/JP2021/035364

§ 371 Date: Mar. 27, 2023

(30) Foreign Application Priority Data
Sep. 28, 2020 (JP) 2020-162358

(51) Int. Cl. C03B 37/014

(52) U.S. Cl. CPC C03B 37/01406; C03B 2207/42; C03B 2207/50

(57) ABSTRACT

A method for manufacturing an optical fiber preform includes a core part deposition process and a clad part deposition process. The number of burners used in the core part deposition process is less than the number of burners used in the clad part deposition process. A distance between turning back points in a first reciprocating motion for the core deposition process is equal to or greater than a length of an effective portion of the optical fiber preform. At least three burners are used in the clad part deposition process. A distance between turning back points in a second reciprocating motion for the clad part deposition process is shorter than a distance between turning back points in the first reciprocating motion. The turning back points in the second reciprocating motion vary during the clad part deposition process.

### TECHNICAL FIELD

The present disclosure relates to a method and a facility for manufacturing an optical fiber preform. This application claims priority based on Japanese Patent Application No. 2020-162358 filed on Sep. 28, 2020, the contents of which are incorporated herein by reference in its entirety.

### BACKGROUND ART

Vapor-phase Axial Deposition (VAD) method and Outside Vapor Deposition (OVD) method are known as the methods for manufacturing an optical fiber preform. Patent Literature 1 discloses a method of reciprocating a target material with respect to a plurality of burners when depositing soot on the target material by the OVD method. The reciprocating movement in Patent Literature 1 is a simple reciprocation between predetermined points.

Patent Literature 2 discloses a method for manufacturing a porous glass preform using the OVD method, which deposits glass soot on a starting member by generating relative oscillatory motion between a plurality of burner arrays arranged along the length of the preform and the starting member. The oscillatory motion described in Patent Literature 2 is a repeated reciprocation over a length less than the full length of the preform, and the turning back point is changed in the manufacturing process.

### CITATION LIST

### Patent Literature

Patent Literature 1: JPS63-310745A

Patent Literature 2: JPH04-260618A

### SUMMARY OF INVENTION

A method for manufacturing an optical fiber preform according to an aspect of the present disclosure is
a method for manufacturing an optical fiber preform having a core part and a clad part using a manufacturing facility provided with at least three burners, in which the method includes
a core part deposition process of, while relatively moving the burners and a first target material in a first reciprocating motion, depositing core glass particles generated in a flame formed by the burners on the first target material, and
a clad part deposition process of, while relatively moving the burners and a second target material including the core part obtained through the core part deposition process in a second reciprocating motion, depositing clad glass particles generated in the flame formed by the burners on the core part, in which
the number of the burners used in the core part deposition process is less than the number of the burners used in the clad part deposition process, and a distance between halfway points in the first reciprocating motion is equal to or greater than a length of an effective portion of the optical fiber preform,
at least three burners are used in the clad part deposition process,
a distance between the turning back points in the second reciprocating motion is shorter than the distance between the turning back points in the first reciprocating motion, and
the turning back points in the second reciprocating motion vary during the clad part deposition process.

A facility for manufacturing an optical fiber preform according to an aspect of the present disclosure is
a facility for manufacturing an optical fiber preform including a core part and a clad part, in which the facility includes
at least three burners, and
a reciprocating mechanism for relatively reciprocating the burners and a target material,
in which the number of burners used in a core part deposition process of depositing the core part on a target material is less than the number of burners used in a clad part deposition process of depositing the clad part on the core part, and
when two or more of the burners are used in the core part deposition process, a distance between two outermost burners of the burners used in the core part deposition process is shorter than a distance between two outermost burners of the burners used in the clad part deposition process.

### BRIEF DESCRIPTION OF DRAWINGS

FIG. 1A is a schematic diagram showing a core part deposition process according to an embodiment of the present disclosure.

FIG. 1B is a schematic diagram showing a clad part deposition process according to an embodiment of the present disclosure.

FIG. 2 is a graph showing the relationship between the number of core burners and the deposition rate.

FIG. 3 is a graph showing the relationship between the number of core burners and the required deposition time.

FIG. 4 is a graph showing the relationship between the number of core burners and the reciprocating range.

### DESCRIPTION OF EMBODIMENTS

### Problems to be Solved by the Present Disclosure

With the VAD method that uses one core burner and one clad burner, it is difficult to improve the deposition rate. In addition, since the relative refractive index difference of the core part tends to change in the initial stage of the deposition process, the relative refractive index difference of the core part tends to change in the longitudinal direction of the optical fiber preform. In addition, since the soot is deposited obliquely, there is a problem that it is difficult to control the profile in the radial direction.

As a method for improving the deposition rate and stabilizing the relative refractive index difference in the longitudinal direction and facilitating profile control in the radial direction, the OVD method can be employed. However, in the method disclosed in Patent Literature 1, if the number of burners used is increased, the reciprocating distance is increased by the increased amount. Accordingly, there is a problem that a size of the manufacturing facility is increased. On the other hand, if the number of burners used is decreased, the deposition rate is decreased.

According to the method disclosed in Patent Literature 2, it is possible to improve the deposition rate while suppressing an increase in the size of the manufacturing facility. Meanwhile, when depositing the core part with a method like Patent Literature 2, for example, it is necessary to control, at each burner, the addition amount of dopant such as GeCl₄ as well as the addition amount of SiCl₄ and oxyhydrogen gas, but it is difficult to appropriately perform the control described above at each burner while changing the turning back point of each burner array. Therefore, when the core part is deposited by the method disclosed in Patent Literature 2, the addition amount of Ge or the like tends to change in the longitudinal direction of the optical fiber preform, and the distribution of the refractive index in the longitudinal direction tends to vary. In addition, it is necessary to arrange a mechanism for introducing a dopant such as GeCl₄ over the entire length in the longitudinal direction, which increases the facility cost.

An object of the present disclosure is to provide a method and facility for manufacturing an optical fiber preform, which are capable of achieving a sufficient deposition rate while suppressing an increase in the size of the facility, and also suppressing variations in the distribution of the refractive index in the longitudinal direction.

### Effects of Invention

According to the configuration disclosed above, it is possible to provide a method and facility for manufacturing an optical fiber preform, which are capable of achieving a sufficient deposition rate while suppressing an increase in the size of the facility, and also suppressing variations in the distribution of the refractive index in the longitudinal direction.

### Description of Embodiment of Present Disclosure

First, embodiments of the present disclosure will be listed and described.

A method for manufacturing an optical fiber preform according to an aspect of the present disclosure is
a method for manufacturing an optical fiber preform having a core part and a clad part using a manufacturing facility provided with at least three burners, and the method includes
a core part deposition process of, while relatively moving the burners and a first target material in a first reciprocating motion, depositing core glass particles generated in a flame formed by the burners on the first target material, and
a clad part deposition process of, while relatively moving the burners and a second target material including the core part obtained through the core part deposition process in a second reciprocating motion, depositing clad glass particles generated in the flame formed by the burners on the core part,
in which the number of the burners used in the core part deposition process is less than the number of the burners used in the clad part deposition process, and a distance between turning back points in the first reciprocating motion is equal to or greater than a length of an effective portion of the optical fiber preform,
at least three burners are used in the clad part deposition process,
a distance between turning back points in the second reciprocating motion is shorter than the distance between the halfway points in the first reciprocating motion, and
the turning back points in the second reciprocating motion vary during the clad part deposition process.

According to this configuration, it is possible to achieve a sufficient deposition rate while suppressing an increase in the size of the facility, and it is also possible to suppress variations in the distribution of the refractive index in the longitudinal direction. It is to be noted that when a burner is “used,” it means that the burner is substantially depositing a glass particulate deposit, and burners that are only lit, or burners that introduce only a very small amount of glass raw material gas such as SiCl₄ or siloxane or dopant gas such as GeCl₄ are not counted as the number of burners used.

According to the method for manufacturing the optical fiber preform,
it is preferable that two or more of the burners are used in the core part deposition process, and
a distance between two outermost burners of the burners used in the core part deposition process is shorter than a distance between two outermost burners of the burners used in the clad part deposition process.

According to this configuration, since two or more burners are used in the core part deposition process, the deposition rate of the glass particles can be increased.

According to the method for manufacturing the optical fiber preform,
in the core part deposition process, the raw material gas for the core glass particles may contain GeCl₄.

According to this configuration, the refractive index of the core part can be set within a desired range.

According to the method for manufacturing the optical fiber preform,
preferably, two or more of the burners adjacent to each other are used in the core part deposition process.

According to this configuration, for example, since the burners adjacent to each other are used, the distance moved in the first reciprocating motion can be decreased. As a result, it is possible to further suppress an increase in the size of the facility.

According to the method for manufacturing the optical fiber preform,
in the manufacturing facility, the interval between the burners adjacent to each other is preferably 50 mm to 400 mm.

By setting the interval between the burners adjacent to each other to 50 mm or more, the flames emitted from the burners do not interfere with each other on the deposition surface, leading to an improvement in the deposition rate and yield. Further, by setting the interval between the burners adjacent to each other to 400 mm or less, the distance of each reciprocating motion is decreased, thereby further suppressing an increase in the size of the facility.

A facility for manufacturing an optical fiber preform according to an aspect of the present disclosure is
a facility for manufacturing an optical fiber preform having a core part and a clad part, and includes
at least three burners, and
a reciprocating mechanism for relatively reciprocating the burners and a target material,
in which the number of the burners used in a core part deposition process of depositing the core part on a target material is less than the number of the burners used in a clad part deposition process of depositing the clad part on the core part, and
when two or more of the burners are used in the core part deposition process, a distance between two outermost burners of the burners used in the core part deposition process is shorter than a distance between two outermost burners of the burners used in the clad part deposition process.

According to this configuration, it is possible to achieve a sufficient deposition rate while suppressing an increase in the size of the facility, and it is also possible to suppress variations in the distribution of the refractive index in the longitudinal direction.

### Details of Embodiments of Present Disclosure

An embodiment of the present disclosure will be described with reference to the drawings. In the following description, even in different drawings, the same or equivalent elements are denoted by the same reference numerals or names, and duplicate description will be omitted.

### Manufacturing Facility of Optical Fiber Preform

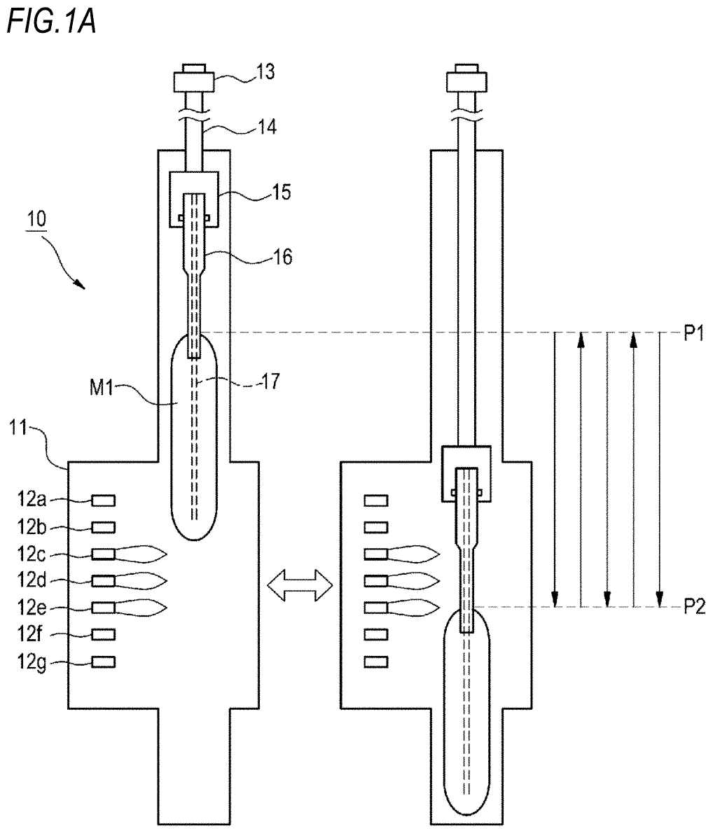

FIG. 1A is a schematic diagram illustrating a core part deposition process according to an embodiment of the present disclosure. FIG. 1B is a schematic diagram illustrating a clad part deposition process according to an embodiment of the present disclosure. First, a manufacturing facility 10 of an optical fiber preform according to the present embodiment will be described with reference to FIGS. 1A and 1B. The manufacturing facility 10 is a facility for manufacturing an optical fiber preform M1 having a core part or the core part and a portion of a clad part, and an optical fiber preform M2 having the core part and the clad part by the OVD method. The manufacturing facility 10 includes a furnace 11, burners 12a to 12g, a lifting device (reciprocating mechanism) 13, a support rod 14, and a holder 15.

In the core part deposition process, a seed rod pipe 16 and a starting rod (first target material) 17 are placed in the furnace 11. In the clad part deposition process, a starting member (second target material) 18 is placed in the furnace 11. In this specification, the first target material and the second target material are also collectively referred to simply as a “target material”. The furnace 11 is a container having an inner space where the glass particles are deposited on a target material. The furnace 11 is made of a material that is resistant to corrosion by hydrogen chloride gas or the like even under high-temperature environmental conditions for forming an optical fiber preform, and includes silicon dioxide, silicon carbide, nickel, or a nickel alloy, for example.

The support rod 14 is inserted into the furnace 11 from above the furnace 11. The holder 15 is connected to a lower end of the support rod 14. The holder 15 holds the target material directly or indirectly. Further, the holder 15 can rotate the held target material about the axis of the target material.

The seed rod pipe 16 is made of quartz glass, for example. The starting rod 17 is made of materials such as alumina, glass, refractory ceramics, and carbon. For example, the starting member 18 is a member obtained by solidifying and stretching the optical fiber preform M1 obtained through the core part deposition process. An upper end of the support rod 14 is connected to the lifting device 13. The lifting device 13 can vertically reciprocate the target material by vertically reciprocating the support rod 14.

The furnace 11 is provided with a plurality of burners 12a to 12g (hereinafter also collectively referred to as “burner 12”) along a direction in which the target material is reciprocated (the vertical direction in the example of FIG. 1A). The number of burners provided in the manufacturing facility 10 is not particularly limited as long as there are three or more of these. In the manufacturing facility 10, the interval between the burners adjacent to each other is preferably 50 mm to 400 mm. Moreover, from the viewpoint of stabilizing the distribution of the refractive index of the optical fiber preform, it is preferable that the burners, or in particular, the clad burners used in the clad part deposition process are arranged at regular intervals.

The burner 12 has a plurality of ports for blowing out gas. Each port communicates with a pipe for supplying glass raw material gas containing SiCl₄, siloxane, and the like, or with a pipe for supplying a flame forming gas such as oxyhydrogen gas. The core burner used in the core part deposition process also communicates with a pipe that supplies a dopant gas such as GeCl₄. To make it easier to suppress the increase in size of the facility and also to suppress the cost of the facility, it is preferable that certain clad burners are also used as the core burners.

The number of core burners is not particularly limited as long as it is less than the number of clad burners. Although one core burner may be used, it is preferable that there are two or more of these burners adjacent to each other in the manufacturing facility 10, for example. In addition, to achieve a good balance between suppressing the increase of the size of the facility and improving the deposition rate, there are preferably about 3/10 to 5/10 of the number of clad burners.

In addition, when two or more core burners are provided, in order to prevent an increase in the size of the facility, it is preferable that the distance between two outermost burners of the core burners is shorter than the distance between two outermost burners of the clad burners.

In the example of FIG. 1A, the three burners 12c to 12e are burners used in the core part deposition process. As shown in FIG. 1B, seven burners 12a to 12g of the clad burners are used in the clad part deposition process. The three burners 12c to 12e are burners that serve as both the core burner and the clad burner. In addition, the distance between an uppermost burner 12c and a lowermost burner 12e of the core burners, that is, the distance between the two outermost burners of the core burners is shorter than the distance between the uppermost burner 12a and the lowermost burner 12g of the clad burners, that is, the distance between the two outermost burners of the clad burners.

The furnace 11 is provided with an exhaust port (not shown) for discharging the exhaust gas. An exhaust pipe is connected to the exhaust port, and internal exhaust gas containing surplus glass particles not deposited on the target material is delivered from the exhaust port into the exhaust pipe.

Although the manufacturing facility 10 shown in FIGS. 1A and 1B reciprocates the target material in the vertical direction, it may be configured such that the burner 12 is reciprocated in the vertical direction. Further, the direction of reciprocation may be the axial direction of the target material, and the direction of reciprocation depends on how the target material is held. For example, when the axial direction of the target material is the horizontal direction, the manufacturing facility 10 is configured such that the burner 12 and the target material can be reciprocated relative to each other in the horizontal direction.

### Method for Manufacturing Optical Fiber Preform

A method for manufacturing an optical fiber preform according to the present embodiment will be described below with reference to FIGS. 1A and 1B. The manufacturing method according to the present embodiment is a method for manufacturing the optical fiber preform M1 having a core part, the core part and a portion of a clad part, and the M2 having the core part and the clad part by the OVD method, using the manufacturing facility 10 provided with at least three burners 12, and the manufacturing method includes a core part deposition process and a clad part deposition process.

The core part deposition process includes, while relatively moving the core burner and the starting rod 17 in a first reciprocating motion, depositing the core glass particles generated in the flame formed by the core burner on the starting rod 17, so as to manufacture the optical fiber preform M1 having the glass particles of the core part deposited on the surface. As already mentioned, in the example shown in FIG. 1A, the burners 12c to 12e are used as the core burners.

In the core part deposition process, the core burners 12c to 12e are supplied with glass raw material gas and flame forming gas. The glass raw material gas contains SiCl₄ or siloxane, for example. Further, the glass raw material gas used in the core part deposition process preferably contains GeCl₄ as a dopant, for example. The amount of GeCl₄ to be introduced is not particularly limited, but, from the viewpoint of increasing the deposition amount, for example, it is preferably 0.1 g/min or more, or more preferably, 0.5 g/min or more.

When SiCl₄ and GeCl₄ are used as the glass raw material gases, core glass particles containing SiO₂ and GeO₂ as the main components are generated in the flames of the burners 12c to 12e. For example, the flame forming gas is an oxyhydrogen gas containing hydrogen which is a combustible gas, and oxygen which is a combustion-supporting gas.

The core part deposition process includes, for example, while ejecting the glass raw material gas and the flame forming gas from the burners 12c to 12e and rotating the starting rod 17 about the axis of the starting rod 17 by the holder 15, moving the starting rod 17 in a first reciprocating motion along the axial direction thereof

In this example, the first reciprocating motion is a simple reciprocating motion between two turning back points. In the example of FIG. 1A, there is a simple reciprocating motion between a turning back point P1 and a turning back point P2 as indicated by the arrow. In the core part deposition process, the simple reciprocating motion makes it easy to equalize the amount of Ge introduced in the longitudinal direction of the optical fiber preform M1. That is, it is easy to control the distribution of the refractive index.

The turning back point P1 is near the position of the upper end of the optical fiber preform M1 when the lower end of the optical fiber preform M1 (near the lower end of the starting rod 17) is at the same height as the uppermost burner 12c of the core burners. The turning back point P2 is near the position of the upper end of the optical fiber preform M1 when the upper end of the optical fiber preform M1 is at the same height as the lowest burner 12e of the core burners. When there is one core burner, the turning back point P1 is near the position of the upper end of the optical fiber preform M1 when the lower end of the optical fiber preform M1 is at the same height as the core burner. Likewise, the turning back point P2 is near the position of the upper end of the optical fiber preform M1 when the upper end of the optical fiber preform M1 is at the same height as the core burner.

In any case, the distance between the turning back points P1 and P2 is equal to or greater than the length of the effective portion of the optical fiber preform M1 (for example, a portion used for the optical fiber product, and having a constant diameter after the clad part manufacturing process). In addition, the turning back point P1 may move slightly upward as the length of optical fiber preform M1 increases in the longitudinal direction during the core part deposition process. Likewise, the turning back point P2 may move slightly downward by small increments.

As the number of core burners increases, the distance between the turning back points P1 and P2 increases, and the size of the manufacturing facility 10 increases. However, in the core part deposition process according to the present embodiment, when two or more core burners are provided, the distance between the two outermost burners of the core burners is made shorter than the distance between the two outermost burners of the clad burners. Therefore, the amount of reciprocating motion in the first reciprocating motion is shorter than when all the burners 12 are used, and as a result, an increase in the size of the manufacturing facility 10 can be suppressed.

The clad part deposition process is performed in the same manufacturing facility 10 as the core part deposition process, following the core part deposition process, for example. The clad part deposition process includes, while relatively moving the clad burner and the starting member 18 in a second reciprocating motion, depositing clad glass particles generated in the flame formed by the clad burner on the starting member 18, so as to manufacture the optical fiber preform M2 having the glass particles in the clad part deposited on the surface. As already mentioned, in the example shown in FIG. 1B, the burners 12a to 12g are used as the clad burners. The burners 12c to 12e are burners that serve as both the core burner and the clad burner.

In the clad part deposition process, the clad burners 12a to 12g are supplied with a glass raw material gas and a flame forming gas. The glass raw material gas contains SiCl₄ or siloxane, for example. Meanwhile, the glass raw material gas used in the clad part deposition process does not contain dopants such as GeCl₄. In the clad part deposition process, clad glass particles mainly including SiO₂ are generated in the flames of the burners 12a to 12g. For example, the flame forming gas is an oxyhydrogen gas containing hydrogen which is a combustible gas, and oxygen which is a combustion-supporting gas.

The clad part deposition process includes, for example, while ejecting the glass raw material gas and the flame forming gas from the burners 12a to 12g and rotating the starting member 18 about the axis of the starting member 18 by the holder 15, moving the starting member 18 in a second reciprocating motion along the axial direction thereof.

In this case, the second reciprocating motion is a reciprocating motion with varying turning back points during the clad part deposition process. In the example of FIG. 1B, the reciprocating motion is performed between turning back points P3 and P8 while repeatedly changing the turning back points as indicated by the arrows. Specifically, first, the upper end of the optical fiber preform M2 is moved downward from the state of being at the turning back point P3, and when the upper end of the optical fiber preform M2 reaches the turning back point P4, the moving direction is reversed upward. Next, when the upper end of the optical fiber preform M2 reaches the turning back point P5, the moving direction is reversed downward. The moving direction is also reversed at each of the turning back points P6 and P7, and the upper end of the optical fiber preform M2 reaches the turning back point P8. Then, in the same way, the reciprocating motion is continued toward the turning back point P3 while repeatedly changing the turning back point and reversing the moving direction.

The distance between the turning back points P3 and P8 is shorter than the distance between the turning back points P1 and P2 in the first reciprocating motion. Further, the turning back point P3 is near the position of the upper end of the optical fiber preform M2 when the lower end of the optical fiber preform M2 is at the same height as the burner 12f which is the second from the lowest one of the clad burners, for example. The turning back point P8 is near the position of the upper end of the optical fiber preform M2 when the upper end of the optical fiber preform M2 is at the same height as a burner 12b which is the second from the uppermost one of the clad burners, for example. By setting the turning back points P3 and P8 as described above, the clad glass particles are always applied to the optical fiber preform M2 from the burner 12 having “one or more clad burners,” and accordingly, it is possible to improve the deposition rate. Further, the non-effective portion of the optical fiber preform M2 can be shortened.

The optical fiber preform M2 obtained as described above is further subjected to a consolidating process, a jacket portion deposition process, a wire drawing process, and the like, to be an optical fiber product.

### EXAMPLES

Hereinafter, the present disclosure will be described in more detail by referring to Manufacturing Examples 1 to 11 as the Examples and Comparative Examples according to the present disclosure. In the following description, Manufacturing Examples 1 to 9 are the Examples, and Manufacturing Examples 10 and 11 are the Comparative Examples. Note that the present disclosure is not limited to these examples.

### Manufacturing Example 1

An optical fiber preform including a core part and a clad part was manufactured using a φ10 mm alumina mandrel as a starting rod in a manufacturing facility provided with ten burners at intervals of 150 mm. In the core part deposition process, one of the ten burners was used as a core burner, in which, while a glass raw material gas containing SiCl₄ and GeCl₄ and an oxyhydrogen gas were ejected from the core burner and the starting rod was moved in a first reciprocating motion, core glass particles were deposited on the starting rod. In the clad part deposition process, all of the ten burners described above were used as the clad burners, in which, while a glass raw material gas containing SiCl₄ (without dopant gas) and an oxyhydrogen gas were ejected from the clad burner and the starting rod was moved in a second reciprocating motion, clad glass particles was deposited on the core part so that an optical fiber preform of Manufacturing Example 1 was obtained. The manufacturing conditions include the optical fiber preform after consolidating with an outer diameter of 50 mm, an inner diameter of 5 mm, a length of 1000 mm, and a clad diameter/core diameter of 5, and the soot before consolidating with an outer diameter of 100 mm, an inner diameter of 10 mm, a length of 1380 mm, a soot weight of 4320 g, and a bulk density of 0.4 g/cm³.

### Manufacturing Examples 2 to 10

Optical fiber preforms of Manufacturing Examples 2 to 10 were manufactured in the same manner as in Manufacturing Example 1, except that the number of core burners used was changed. The number of core burners in Manufacturing Examples 2 to 10 was 2 to 10, respectively. In addition, in each of Manufacturing Examples 2 to 10, a series of burners adjacent to each other were used as the core burners.

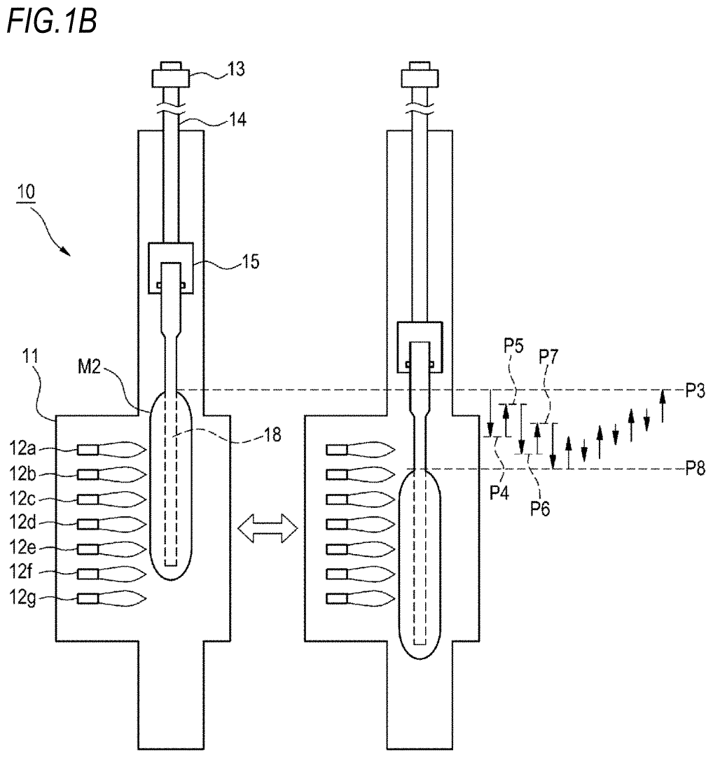

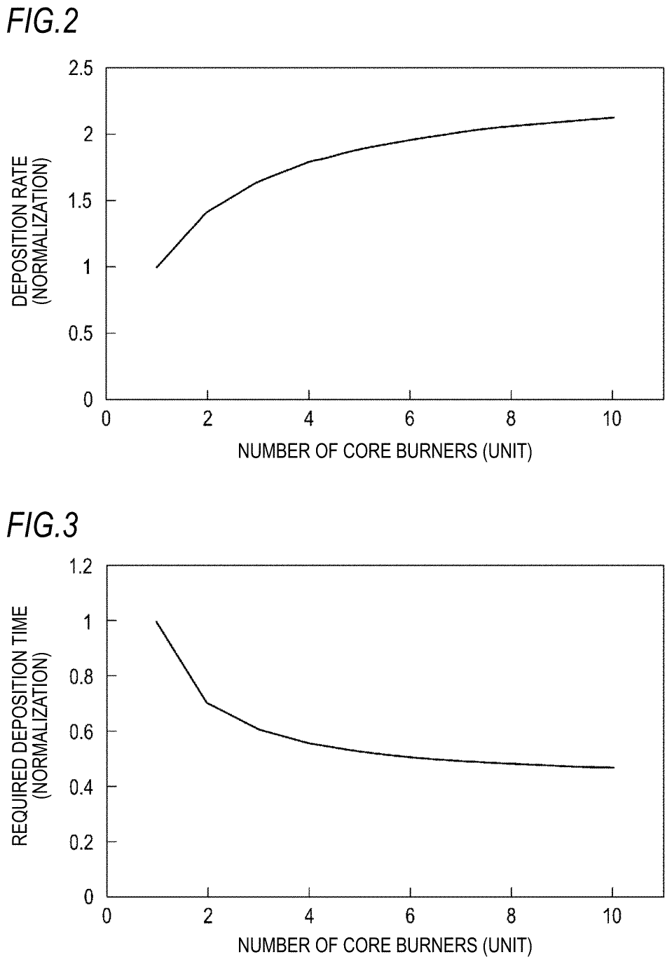

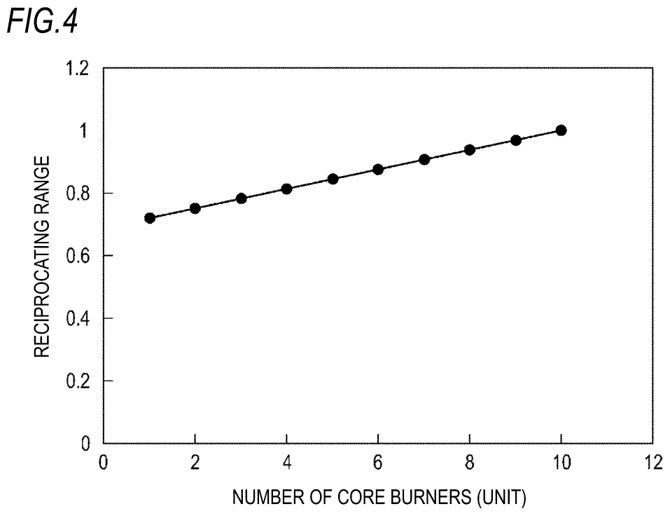

FIGS. 2 to 4 respectively show the deposition rate, required deposition time, and range of the first reciprocating motion during the manufacture of the core part in Manufacturing Examples 1 to 10. The deposition rates on the vertical axis in FIG. 2 are normalized values based on the deposition rate of Manufacturing Example 1 (with one core burner) (when the deposition rate of Manufacturing Example 1 is set to 1.0). The required deposition times on the vertical axis in FIG. 3 are normalized values based on the required deposition time of Manufacturing Example 1 (with one core burner) (when the required deposition time of Manufacturing Example 1 is set to 1.0). The reciprocating ranges of the vertical axis in FIG. 4 are normalized values based on the reciprocating range in the first reciprocating motion of Manufacturing Example 10 (with 10 core burners) (when the reciprocating range of Manufacturing Example 10 is set to 1.0).

From FIGS. 2 and 3, it can be seen that the deposition rate is increased and the required deposition time is decreased as the number of core burners is increased. Meanwhile, if the number of core burners is seven or more, it can be seen that the improvement in the deposition rate slows down despite the increased number of core burners. From FIG. 4, it can be seen that if the number of core burners is increased, the range of the first reciprocating motion is increased linearly. That is, as the number of core burners increases, the size of the manufacturing facility increases linearly. From the above results, in order to achieve a good balance between improving the deposition rate to shorten the required deposition time and suppressing the increase in the size of the facility, it is considered desirable to set the number of core burners to 2 or more and ⅔ or less of the number of clad burners.

### Manufacturing Example 3

After manufacturing 30 optical fiber preforms under the conditions of Manufacturing Example 3 (with three core burners) described above, the ratio of the clad diameter to the core diameter (clad diameter/core diameter) was calculated at a position (0 mm), which is the upper end of the effective portion of the manufactured optical fiber preform, and positions down from the upper end toward the lower end, that is, at 250 m, 500 mm, 750 mm, and 1000 mm, respectively.

### Manufacturing Example 11

Using the VAD method, 30 optical fiber preforms of Manufacturing Example 11 were manufactured under the conditions including the optical fiber preform after consolidating having an outer diameter of 50 mm, a length of 1000 mm, a clad diameter/core diameter of 5, and the soot before consolidating having an outer diameter of 100 mm, a length of 1380 mm, a soot weight of 4320 g, and a bulk density of 0.4 g/cm³. For the dopant gas for the core part, GeCl₄ was used. Regarding the optical fiber preform of Manufacturing Example 11, the ratio of the clad diameter to the core diameter at each position was calculated in the same manner as in Manufacturing Example 3. As a result, the clad diameter/core diameter variation 3σ was worsened by 36% as compared with Manufacturing Example 3.

From the above results, it can be seen that, with the method for manufacturing an optical fiber preform according to the present disclosure, it is possible to manufacture an optical fiber preform with a smaller variation rate and variation in the clad diameter/core diameter and less variation in the diameter in the longitudinal direction than the related manufacturing method using the VAD method.

As described above, while the invention has been described in detail and with reference to specific embodiments thereof, it will be apparent to those skilled in the art that various changes and modifications can be made without departing from the spirit and scope of the invention. Further, the number, the position, the shape, and the like of the above-described constituent members are not limited to the above embodiments, and can be changed to a suitable number, a position, a shape, and the like for implementing the present invention.

### REFERENCE SIGNS LIST

10: facility for manufacturing (optical fiber preform)
11: furnace
12a to 12g: burners
13: lifting device (reciprocating mechanism)
14: support rod
15: holder
16: seed rod pipe
17: starting rod (first target material)
18: starting member (second target material)
M1, M2: optical fiber preforms (optical fiber base material)
P1 to P8: turning back points

1. A method for manufacturing an optical fiber preform including a core part and a clad part using a manufacturing facility provided with at least three burners, the method comprising:
a core part deposition process of, while relatively moving the burners and a first target material in a first reciprocating motion, depositing core glass particles generated in a flame formed by the burners on the first target material; and
a clad part deposition process of, while relatively moving the burners and a second target material including the core part obtained through the core part deposition process in a second reciprocating motion, depositing clad glass particles generated in the flame formed by the burners on the core part, wherein
the number of the burners used in the core part deposition process is less than the number of the burners used in the clad part deposition process,
a distance between turning back points in the first reciprocating motion is equal to or greater than a length of an effective portion of the optical fiber preform,
at least three burners are used in the clad part deposition process,
a distance between turning back points in the second reciprocating motion is shorter than the distance between the turning back points in the first reciprocating motion, and
the turning back points in the second reciprocating motion vary during the clad part deposition process.

2. The method for manufacturing an optical fiber preform according to claim 1, wherein two or more of the burners are used in the core part deposition process, and
a distance between two outermost burners of the burners used in the core part deposition process is shorter than a distance between two outermost burners of the burners used in the clad part deposition process.

3. The method for manufacturing an optical fiber preform according to claim 1, wherein, in the core part deposition process, raw material gas for the core glass particles includes GeCl₄.

4. The method for manufacturing an optical fiber preform according to claim 1, wherein, in the core part deposition process, two or more of the burners adjacent to each other are used.

5. The method for manufacturing an optical fiber preform according to claim 1, wherein, in the manufacturing facility, an interval between the burners adjacent to each other is 50 mm or more and 400 mm or less.

6. A facility for manufacturing an optical fiber preform including a core part and a clad part, the facility comprising:
at least three burners; and
a reciprocating mechanism for relatively reciprocating the burners and a target material, wherein the number of burners used in a core part deposition process of depositing the core part on a target material is less than the number of burners used in a clad part deposition process of depositing the clad part on the core part, and
when two or more of the burners are used in the core part deposition process, a distance between two outermost burners of the burners used in the core part deposition process is shorter than a distance between two outermost burners of the burners used in the clad part deposition process.
